(19) United States
(12) Patent Application Publication
(10) Pub. No.: US 2008/0154410 A1
(43) Pub. Date: Jun. 26, 2008

(54) METHOD FOR CLEANING VACUUM APPARATUS, DEVICE FOR CONTROLLING VACUUM APPARATUS, AND COMPUTER-READABLE STORAGE MEDIUM STORING CONTROL PROGRAM

(75) Inventor: Hiroshi NAKAMURA, Yamanashi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/959,891

(22) Filed: Dec. 19, 2007

Related U.S. Application Data
(60) Provisional application No. 60/896,358, filed on Mar. 22, 2007.

(30) Foreign Application Priority Data
Dec. 22, 2006 (JP) JP2006-346241

(51) Int. Cl. G06F 9/00; B08B 5/00

(52) U.S. Cl. 700/95; 134/21

(57) ABSTRACT

A vacuum apparatus such as PM 400 or LMM 500 includes: a chamber to transfer or process a wafer; a plurality of movable parts in the chamber; a high-voltage power supply 485 to introduce a high voltage HV to the chamber; a gas supply unit 445 to supply a gas to the chamber; and an exhaust mechanism 490 to exhaust a purge gas in the chamber. The vacuum apparatus is cleaned by supplying the purge gas from the gas supply unit 445 and exhausting the purge gas in the chamber via the exhaust mechanism 490, repeating a motion of each movable part, and controlling the purge-gas pressure to be equal to or more than a predetermined pressure before and/or during and/or after the repeated motions of each movable part, and/or allowing the power supply 485 to intermittently output the HV before and/or after the motions of each movable part.

### CROSS-REFERENCE TO RELATED APPLICATIONS

The present invention contains subject matter related to Japanese Patent Application No. 2006-346241, filed on Dec. 22, 2006 and Provisional Application No. 60/896, 358, filed on Mar. 22, 2007, the entire contents of which being incorporated herein by reference.

### BACKGROUND OF THE INVENTION

1. Field of the Invention

The present invention relates to a method for cleaning a vacuum apparatus, a control device for controlling the cleaning of the vacuum apparatus, and a computer-readable storage medium storing the control program. More particularly, the present invention relates to a method for cleaning a vacuum apparatus and a movable part disposed therein.

2. Description of the Related Art

Vacuum apparatuses allow process gases to be used therein to perform desired processes on target objects. During the processes, reaction products from the process gases are attached to the inside of vacuum chambers and are gradually deposited on the wall surfaces inside the chambers or the like. The deposits are heated when, for example, the target objects are subject to deposition. The deposits are also cooled when, for example, the target objects are loaded/unloaded from the vacuum apparatuses. As the heating and cooling are repeated, the thermal expansion coefficient difference between the deposits and the members to which the deposits adhere in the vacuum apparatuses (such as chamber interior walls) causes distortion between the deposits and the members. At a certain thickness of the deposits, therefore, they peel off the members.

Particularly, reaction products attached to movable parts disposed in the vacuum apparatuses cause particles for the reason as follows. Deposits on gate valves for loading/unloading the target objects, for example, peel off when the valves open and close to load/unload the objects. The peeled deposits provide dusts. The dusts cause the particles and may be brought into the vacuum chambers. Deposits on the valve elements of the automatic pressure controllers (APC), for example, peel off when the valve elements open and close to adjust the exhaust of the gases from the apparatuses. The peeled deposits provide dusts. The dusts may not be exhausted and be returned into the vacuum chambers. The dusts drop on the target objects as the particles. The particles degrade the characteristics of the devices formed on the target objects, contributing to the decrease in the product yield.

In order to remove the particles thus generated, a method for cleaning a vacuum apparatus and a method for measuring cleanliness in the cleaned vacuum apparatus have been proposed (see, for example, Japanese Patent Laid-Open Application No. 2003-168679 and Japanese Patent Laid-Open Application No. 2005-317900). JP 2003-168679 discloses a method for cleaning a vacuum apparatus in which a main-gas line and cleaning-gas lines for respective movable parts are provided, and the cleaning gases from the cleaning-gas lines are sprayed to the respective movable parts, thus cleaning the vacuum apparatus. JP 2005-317900 discloses a method for evaluating cleanliness of the vacuum apparatus by monitoring the particles.

### SUMMARY OF THE INVENTION

Unfortunately, JP 2003-168679 discloses that the cleaning-gas lines have a complicated configuration in which the lines direct the gas nozzles toward respective movable parts in the interior of the vacuum apparatus. The cleaning-gas lines may thus contribute to more particles generated in the interior of the vacuum apparatus.

JP 2005-317900 discloses that the vacuum apparatus is cleaned when it is stopped, so the particles are monitored with the depositions left in those of the movable parts that are accommodated. Those portions are hard to clean. It may thus be hard to correctly evaluate the cleanliness of the vacuum apparatus, preventing the appropriate cleaning.

In view thereof, it is an object of the present invention to provide a method for cleaning a vacuum apparatus, the method effectively removing the deposits attached to the vacuum apparatus and the movable parts disposed therein, a control device for controlling the cleaning of the vacuum apparatus, and a computer-readable storage medium storing the control program.

To solve the issue, therefore, an embodiment of the present invention provides a method for cleaning a vacuum apparatus, the vacuum apparatus including: a chamber to process or transfer a target object; a plurality of movable parts disposed in the chamber; a power supply to introduce an energy to the chamber; a gas supply unit to supply a gas to the chamber; and an exhaust mechanism to exhaust a gas in the chamber.

The method for cleaning a vacuum apparatus comprises: supplying a purge gas from the gas supply unit and exhausting the supplied purge gas via the exhaust mechanism; repeating a motion of each movable part; and controlling the purge-gas pressure to be equal to or more than a predetermined pressure before and/or during and/or after the repeated motions of each movable part, and/or allowing the power supply to intermittently output energy before and/or after the repeated motions of each movable part in order to peel a deposit attached to the vacuum apparatus and each movable part.

A purge gas is thus introduced into the vacuum apparatus while a plurality of movable parts are repeatedly moved, thereby positively peeling off the deposits (reaction products) attached to the movable parts. In addition, the method comprises: supplying a purge gas from the gas supply unit and exhausting the purge gas in the chamber via the exhaust mechanism; repeating a motion of each movable part; and controlling the purge-gas pressure to be equal to or more than a predetermined pressure before and/or during and/or after the repeated motions of each movable part, and/or allowing the power supply to intermittently output energy before and/or after the repeated motions of each movable part in order to peel a deposit attached to the vacuum apparatus and each movable part.

In this way, the purge-gas pressure is controlled to be equal to or more than a predetermined pressure while the purge gas is flowed into and exhausted from the vacuum apparatus, or the purge gas is flowed into and exhausted from the vacuum apparatus while the power supply is allowed to intermittently introduce energy into the vacuum apparatus. These operations are hereinafter also referred to as a non-plasma particle cleaning (NPPC).

A purge gas at a predetermined pressure or more is thus rapidly flowed into the vacuum apparatus. The rapid purge gas generates a shock wave in the vacuum apparatus. The shock wave provides physical oscillations. The oscillations may effectively peel off the deposits attached to the interior of the vacuum apparatus and the movable parts disposed therein.

Also, the power supply is allowed to intermittently output energy into the vacuum apparatus. The intermittent energy instantaneously forms a potential gradient at the wall surface of the vacuum apparatus and the stage bearing a target object. The potential gradient may generate an electromagnetic stress. The electromagnetic stress may thus effectively peel the deposits attached to the interior of the vacuum apparatus and the movable parts disposed therein. Note, however, that when the power supply introduces energy into the vacuum apparatus during the repeated motions of each movable part, it is very likely for the movable parts to undergo a concentrated electrical field, thereby causing an abnormal discharge. The power supply outputs energy, therefore, not during the repeated motions of each movable part but before and/or after the motions. The purge-gas pressure may be controlled to be equal to or more than a predetermined pressure before and/or during and/or after the repeated motions of each movable part.

In order to further effectively peel the deposits attached to the vacuum apparatus and each movable part, it is preferable that the purge-gas pressure is controlled to be equal to or more than a predetermined pressure, and/or the power supply is allowed to intermittently output energy with a valve element of a pressure controller full open, and then the power supply is allowed to intermittently output energy.

In performing the NPPC, therefore, when the vacuum apparatus is at a low pressure (a high degree of vacuum), the purge-gas pressure is controlled to be equal to or more than a predetermined pressure, and/or the power supply is allowed to intermittently output energy with a valve element of a pressure controller full open. The vacuum apparatus is then roughly pumped and controlled to be at a high pressure (a low degree of vacuum) while the power supply is allowed to intermittently output energy into the apparatus. Because, therefore, the vacuum apparatus has a higher resistance at a higher pressure than at a lower pressure and so the deposits may be peeled off more easily, the deposits may be peeled off very effectively. Note that the purge gas may be an inert gas such as N₂ gas.

Examples of the motions of the movable parts disposed in the vacuum apparatus include: opening and closing of a gate valve to load/unload the target object; moving up and down of a stage bearing a target object; up-and-down motion of a lift pin supporting the target object mounted on the stage; and opening and closing of a valve element of an automatic pressure controller.

These movable parts are hard to clean when they are stopped because they are usually accommodated when stopped. According to an embodiment of the present invention, the purge gas is introduced and the NPPC is performed before and/or during and/or after the repeated motions of each movable part. Without using a new device, therefore, the depositions (reaction products) left in those of the movable parts that are accommodated, those movable parts being hard to clean using only the existing device, may be positively peeled off and the peeled reaction products may be effectively exhausted from the vacuum apparatus using the purge gas. Higher cleanliness of the vacuum apparatus may thus be provided, thereby minimizing the frequency of particles dropping on the target object. The product yield may thus be dramatically improved.

Note that the purge-gas pressure is controlled to be higher than the pressure in the vacuum apparatus, and preferably the purge-gas pressure is controlled to be twice or more the pressure of the vacuum apparatus to effectively generate the shock wave of the purge gas.

The power supply is allowed to intermittently introduce energy into the vacuum chamber. The energy may be introduced using various methods including repeated turning on/off of the power supply to output a certain voltage intermittently. More preferably, the power supply is allowed to output a positive voltage and a negative voltage alternately. The energy may be a dc voltage (HV) from a high-voltage power supply or an ac voltage (RF) from a high-frequency power supply.

While the method for cleaning a vacuum apparatus is being performed, the number of particles in the chamber may be monitored using a particle monitor, and the repeated motions of the movable parts may be stopped when the number of particles in the chamber is equal to or less than a predetermined threshold.

When, therefore, the number of particles in the chamber defining the space of the vacuum apparatus is less than a predetermined threshold, the repeated motions of each movable part are ended. The interior of the vacuum apparatus may thus be cleaned sufficiently to a predetermined degree.

When, in comparison with a motion time counted between the start and stop of the repeated motions of the movable parts during a previous cleaning of the vacuum apparatus, the time of the repeated motions of the movable parts during the current cleaning of the vacuum apparatus is equal to or more than a predetermined value corresponding to the counted motion time, the repeated motions of the movable parts may be stopped regardless of the number of particles from the movable parts monitored by the particle monitor.

Alternatively, or additionally, when, in comparison with the number of motions counted between the start and stop of the repeated motions of each movable part during a previous cleaning of the vacuum apparatus, the number of repeated motions of the each movable part during the current cleaning of the vacuum apparatus is equal to or more than a predetermined value corresponding to the counted number of motions of the each movable part, the repeated motions of the each movable part may be stopped regardless of the number of particles from the movable parts monitored by the particle monitor.

When, therefore, any of the movable parts has an abnormality that causes the number of particles from each movable part not to be equal to or less than a predetermined threshold, the number or time of repeated motions of each movable part during a previous cleaning may be used to limit the repeated motions of each movable part during the current cleaning. When, therefore, for example, any of the movable parts has an abnormality in which the part generates particles due to mechanical wear or the like, it is possible to avoid unnecessary motions of each movable part according to an empirical value at a previous cleaning. Note that the number or time of repeated motions of each movable part during previous cleaning may be determined according to only the number or time of repeated motions during the preceding cleaning or according to an average of the number or time of repeated motions over a certain number of previous cleanings.

The method for cleaning a vacuum apparatus may be performed before the repeated motions of each movable part, and then the gas supply unit may supply the purge gas and the exhaust mechanism may exhaust the supplied purge gas, while each movable part may be repeatedly moved in sequence and the number of particles from each movable part due to the repeated motions may be monitored using a particle monitor.

The number of particles from each movable part is thus monitored by the particle monitor. A movable part having the number of particles equal to or more than a predetermined value may thus be identified as the particle source. The movable part thus identified as the particle source may be informed to the operator, thus prompting the operator to exchange or clean that movable part.

The method for cleaning a vacuum apparatus may be performed after the gas supply unit supplies a cleaning gas to the vacuum apparatus to clean it. After the interior of the vacuum apparatus is cleaned using the cleaning gas, therefore, the number of particles from each movable part may be monitored by the particle monitor. The particle source may thus be identified more accurately.

Preferably, the method for cleaning a vacuum apparatus is performed after the vacuum apparatus is cleaned using the cleaning gas and during auto setup for conditioning the interior of the chamber. The auto-setup recipe used in the auto setup describes the procedure of the method for cleaning a vacuum apparatus. The method for cleaning a vacuum apparatus may thus be changed by only changing the auto-setup recipe. The method for cleaning a vacuum apparatus may therefore be managed easily and accurately. Note, however, that, the method for cleaning a vacuum apparatus may be started when the operator operates the “NPPC” button.

The vacuum apparatus may be a semiconductor processing unit. The deposits on the interior wall of the semiconductor processing unit and the movable parts disposed therein may thus be cleaned more effectively, the deposits being gradually accumulated through the etching and the chemical vapor deposition (CVD) performed using the process gases.

Another embodiment of the present invention provides a control device for controlling cleaning of a vacuum apparatus, the vacuum apparatus including: a chamber to process or transfer a target object; a plurality of movable parts disposed in the chamber; a power supply to introduce energy to the chamber; a gas supply unit to supply a gas to the chamber; and an exhaust mechanism to exhaust a gas in the chamber.

The control device comprises: a pressure control unit controlling the gas supply unit to supply a purge gas, the control unit also controlling the exhaust mechanism to exhaust the supplied purge gas; a motion control unit controlling repeated motions of each movable part; and a cleaning execution unit cleaning the vacuum apparatus by controlling the purge-gas pressure to be equal to or more than a predetermined pressure before and/or during and/or after the repeated motions of the each movable part, and/or allowing the power supply to intermittently output energy before and/or after the repeated motions of the each movable part in order to peel a deposit attached to the vacuum apparatus and the each movable part.

Still another embodiment of the present invention provides a computer-readable storage medium storing a control program that instructs a computer to clean a vacuum apparatus, the vacuum apparatus including: a chamber to process or transfer a target object; a plurality of movable parts disposed in the chamber; a power supply to introduce energy to the chamber; a gas supply unit to supply a gas to the chamber; and an exhaust mechanism to exhaust a gas in the chamber.

The control program instructs the computer to execute modules comprising: a module for controlling the gas supply unit to supply a purge gas and controlling the exhaust mechanism to exhaust the supplied purge gas; a module for controlling repeated motions of each movable part; and a module for cleaning the vacuum apparatus by controlling the purge-gas pressure to be equal to or more than a predetermined pressure before and/or during and/or after the repeated motions of the each movable part, and/or allowing the power supply to intermittently output energy before and/or after the repeated motions of the each movable part in order to peel a deposit attached to the vacuum apparatus and the each movable part.

The purge gas is thus introduced and the NPPC is performed before and/or during and/or after the repeated motions of each movable part. Without using a new device, therefore, the depositions (reaction products) left in those of the movable parts that are accommodated may be positively peeled off and the peeled reaction products may be exhausted from the vacuum apparatus using the purge gas. Higher cleanliness of the vacuum apparatus may thus be provided, thereby minimizing the frequency of particles dropping on the target object. The product yield may thus be dramatically improved.

Thus, according to an aspect of the present invention, the deposits attached to the vacuum apparatus and the movable parts disposed therein may be effectively removed.

### BRIEF DESCRIPTION OF THE DRAWINGS

FIG. 1 is a schematic diagram of a substrate processing system 10 according to a first to a third embodiments of the present invention;

FIG. 2 is a hardware configuration diagram of an EC according to the first to third embodiments of the present invention;

FIG. 3 is a configuration diagram of a substrate processing apparatus according to the first to third embodiments of the present invention;

FIG. 4 is a schematic vertical cross-sectional view of a PM according to the first to third embodiments of the present invention;

FIG. 5 is a function configuration diagram of an EC according to the first to third embodiments of the present invention;

FIG. 6 is a flowchart of a particle removal process routine (main routine) performed according to the first to third embodiments of the present invention;

FIG. 7 shows an auto-setup QC check execution confirmation screen;

FIG. 8 is a flowchart of an auto-setup process routine (sub routine) performed in the first embodiment;

FIG. 9 shows an example of an auto-setup recipe;

FIG. 10 shows another example of the auto-setup recipe;

FIG. 11 is a flowchart of an auto-setup process routine performed in the second embodiment; and

FIG. 12 is a flowchart of an auto-setup process routine performed in the third embodiment.

### DETAILED DESCRIPTION OF THE PREFERRED EMBODIMENTS

With reference to the accompanying drawings, preferred embodiments of the present invention will be described in more detail. Note that, in the following discussion and accompanying drawings, the elements having the same configurations and functions are provided with the same reference symbols and their description will be omitted. Note that in the present specification, 1 mTorr equals 133.322×10⁻³ (=101325/760×10⁻³) Pa, and 1 atm equals 101325 Pa.

### First Embodiment

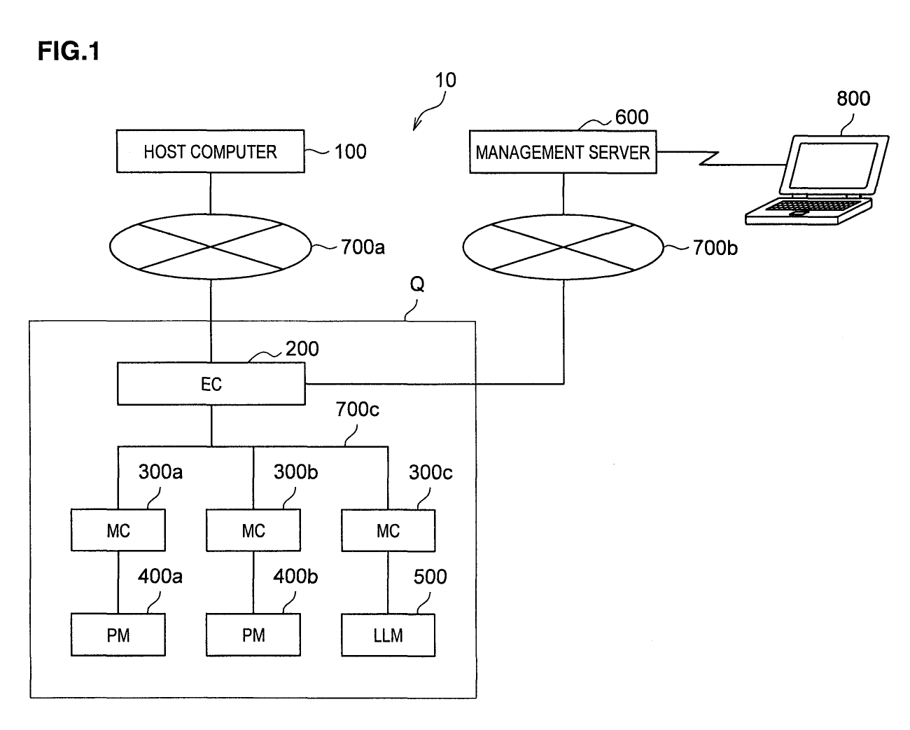

With reference to FIG. 1, a substrate processing system according to a first embodiment of the present invention will be generally described. Note that this embodiment describes a method for cleaning deposits attached to the interior of the vacuum chamber and the movable parts disposed therein, the deposits being formed during etching of the silicon wafer (hereinafter, referred to as the wafer W) using the substrate processing system.

(Substrate processing system) A substrate processing system 10 includes a host computer 100, an equipment controller (hereinafter called the “EC”) 200, three machine controllers (hereinafter called the “MCs”) 300a to 300c, two process modules (hereinafter called the “PMs”) 400a and 400b, one load lock module (hereinafter called the “LLM”) 500, and a management server 600.

The host computer 100 and the EC 200 are connected by a client local area network (LAN) 700a, and the EC 200 and the management server 600 are connected in a client LAN 700b. In addition, the management server 600 is connected to an information processing device, such as a personal computer (PC) 800 or the like. An operator sends instructions to the substrate processing system 10 by operating the PC 800.

The EC 200, the MCs 300a to 300c, the PMs 400a, 400b and the LLM 500 are provided in a specified area Q within a plant and are connected by in-plant LANs respectively.

The host computer 100 controls the entire substrate processing system 10, including data control and the like. The EC 200 holds a system recipe that is used for the process of etching a wafer W. The EC 200 transmits control signals to each of the MCs 300 so as to operate the PMs 400a, 400b and LLM 500 according to the system recipe. The EC 200 also performs revision history control.

The MCs 300a to 300c perform the etching process on the wafer W by driving the PMs 400a, 400b and LLM 500, respectively, based on the control signals transmitted from the EC 200. The PMs 400a and 400b are vacuum processing chambers that perform a predetermined process such as an etching process on the wafer W. The LLM 500 is a vacuum transfer chamber having a decompressed interior to transfer a wafer from the atmosphere to the high-vacuum PMs 400a and 400b. The PMs 400a, 400b, and LLM 500 are all examples of a vacuum apparatus. The management server 600 sets, according to data transmitted from the PC 800 by the operator, the operation condition of each unit or the like.

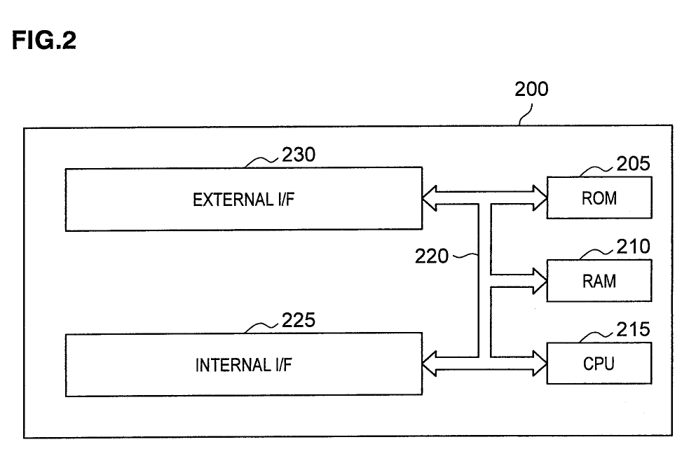

(Hardware configurations of the EC and MC) Next, the hardware configuration of the EC 200 will be explained with reference to FIG. 2. Note that the hardware configurations of the MCs 300 are the same as that of the EC 200, so explanation of these configurations is omitted.

As shown in FIG. 2, the EC 200 includes a ROM 205, a RAM 210, a CPU 215, a bus 220, an internal interface (internal I/F) 225, and an external interface (external I/F) 230.

A basic program that is run by the EC 200, a program that is run when an abnormality occurs, various types of recipes, and the like are stored in the ROM 205. Various types of programs and data are stored in the RAM 210. Note that the ROM 205 and the RAM 210 are examples of storage devices and may be storage devices such as EEPROMs, optical disks, magneto-optical disks, and the like.

The CPU 215 controls the etching process of a wafer W according to the various types of recipes. The CPU 215 also controls the cleaning process of PMs 400 and LLM 500 in a predetermined cycle. The bus 220 is the path by which data is exchanged among the ROM 205, the RAM 210, the CPU 215, the internal interface 225, and the external interface 230.

The internal interface 225 inputs data and outputs required data to a monitor, a speaker, and the like that are not shown in the drawings. The external interface 230 transmits and receives data among devices that are connected in a network such as a LAN or the like.

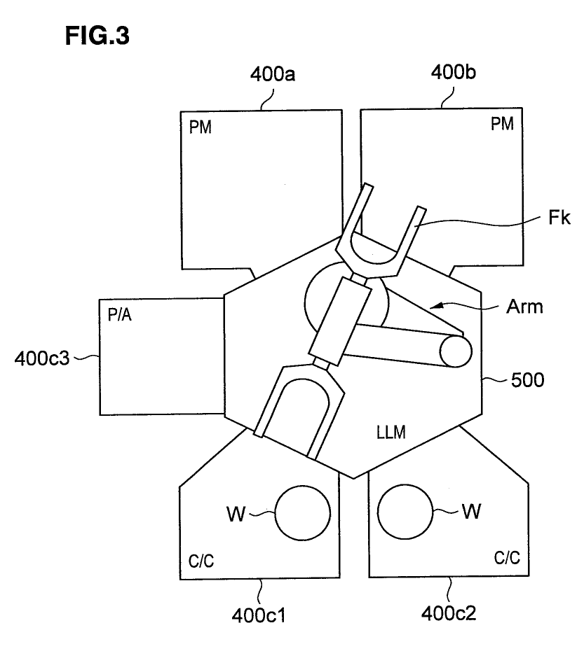

(Hardware configurations of the substrate processing apparatus) Next, the hardware configurations of the substrate processing apparatus including the PMs 400 and the LLM 500 will be explained with reference to FIG. 3. The substrate processing apparatus includes process modules PM 400a, 400b, cassette chambers (C/Cs) 400c1, 400c2, a pre-alignment (P/A) 400c3, and load lock module (LLM) 500.

Unprocessed product wafers and processed product wafers are accommodated in the cassette chambers 400c1, 400c2, and non-product wafers (three, for example) that are used in dummy processes are accommodated at the lowest level of a cassette. The pre-alignment 400c3 performs aligning of the wafer W.

The LLM 500 contains an articulated transfer arm body Arm. The Arm may extend, contract, and swing. The transfer arm Arm has a fork Fk at its end. The arm Arm holds the wafer on the fork Fk. The Arm extends, contracts, and swings as appropriate to transfer the wafer W among the cassette chambers 400c1 and 400c2, the pre-alignment 400c3, and the PMs 400a and 400b. Through the LLM 500, the wafers in the atmosphere cassette chambers 400c1 and 400c2 are transferred to the high-vacuum PMs 400a and 400b, as described above. The LLM 500 is thus supplied with a purge gas from a not-shown gas supply unit, the purge gas being evacuated by a not-shown exhaust mechanism, providing desired decompression of the LLM. Note that the exhaust mechanism and the transfer arm Arm are merely examples of the movable parts disposed in the LLM 500.

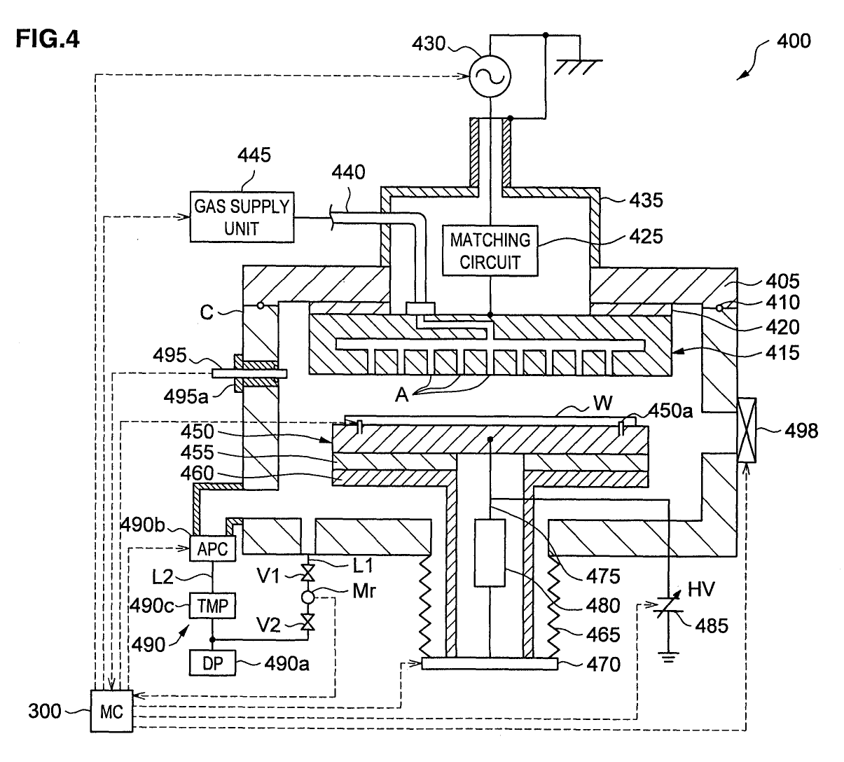

(Internal Structure of PM) FIG. 4 is a schematic vertical cross-sectional view of the PM 400. With reference to FIG. 4, the internal structure of the PM 400 will be described. The PM 400 includes a processing container C of the rectangular tube shape. The container C has a ceiling and a bottom with openings formed in the substantially center portions thereof. The processing container C includes a lid 405 on the ceiling. The lid 405 has an opening at the substantially center portion of the ceiling. An O-ring 410 is provided in the contact surface between the upper portion of a side wall of the processing container C and the lower portion of the periphery of the lid 405. The O-ring 410 maintains the airtightness of the processing container C. The processing container C and the lid 405 define the chamber of the PM 400.

An upper electrode 415 is provided in an upper portion of the interior of the processing container C. The upper electrode 415 is electrically isolated from the processing container C by an insulating material 420 that is provided around the edge of the opening in the top portion of the processing container C. A high-frequency power supply 430 is connected to the upper electrode 415 through a matching circuit 425. A matching box 435 surrounds the matching circuit 425 and is provided to a substantially center portion of the ceiling to serve as a grounded housing for the matching circuit 425 and seal-up the ceiling.

A processing gas supply unit 445 is connected to the upper electrode 415 through a gas line 440. A desired processing gas that is supplied by the processing gas supply unit 445 is introduced into the processing container C through a plurality of gas injection holes A. Thus the upper electrode 415 functions as a gas shower head.

A lower electrode 450 is provided in a lower portion of the interior of the processing container C. The lower electrode 450 functions as a stage on which the wafer W is placed. The lower electrode 450 is supported with a support member 460 through an insulating material 455. The lower electrode 450 is thus electrically isolated from the processing container C. Lift pins 450a are provided on a lower electrode 450 to support the wafer W. The wafer W is placed on the stage and transferred from the stage by moving lift pins 450a up and down.

One end of a bellows 465 is attached close to the perimeter of the opening that is provided in the bottom face of the processing container C. A raising and lowering plate 470 is securely fixed to the other end of the bellows 465. The opening in the bottom face of the processing container C is thus sealed by the bellows 465 and the raising and lowering plate 470. Furthermore, the bellows 465 and the raising and lowering plate 470 move up and down as a single unit with the lower electrode 450 to adjust the position of the lower electrode 450 on which the wafer W is placed to a height that is appropriate to the processing.

The lower electrode 450 is connected to the raising and lowering plate 470 through an electrically conductive path 475 and an impedance adjustment unit 480. The lower electrode 450 is also connected to the high-voltage power supply 485 through an electrically conductive path 475. The wafer W is electrostatically adsorbed to the stage by high voltage HV applied from the high-voltage power supply 485.

The processing container C has an exhaust mechanism 490 connected thereto via a roughing line L1 and a pumping line L2. The roughing line L1 couples a dry pump (DP) 490a that initially evacuates the gas in the processing container C, valves V1 and V2 that control a flow rate of the gas evacuated by the DP 490a, and a particle monitor Mr between the valves V1 and V2 that monitors the number of particles.

The pumping line L2 couples an automatic pressure controller APC 490b that adjusts opening of a valve element to control the internal pressure of the processing container C, and a turbo molecular pump (TMP) 490c that evacuates the gas in the processing container C.

The exhaust mechanism 490 drives the DP 490a with the valves V1 and V2 open to evacuate the gas in the processing container C through the roughing line L1. After the processing container C is evacuated to a predetermined pressure, the exhaust mechanism 490 closes the valves V1 and V2. The mechanism 490 then allows the APC 490b to control the pressure in the processing container and drives the TMP 490c. The TMP 490c evacuates the gas in the processing container C through the pumping line L2 until the processing container C has the desired pressure (a degree of vacuum).

A vacuum gauge 495 is inserted through a fitting 495a disposed on a side wall of the processing container C. The vacuum gauge 495 extends through the side wall of the processing container C. The fitting 495a secures the inserted vacuum gauge 495. The processing-container pressure is detected as needed by the vacuum gauge 495 and sent to the MC 300. According to the detected pressure, the MC 300 sends drive signals to a not-shown mass flow controller (MFC) and the APC 490b. The MFC is thus controlled to adjust a flow rate of a gas flowing into the processing container. The APC 490b's valve element is also controlled to adjust its opening to control a flow rate of the gas exhausted via the exhaust mechanism 490. The processing container may thus be maintained at the desired pressure.

The particle monitor Mr is provided surrounding the roughing line L1. Laser light from a not-shown laser source is introduced into the roughing line L1 in the particle monitor Mr. Particles passing through the roughing line L1 scatter the laser light. The scattered light is received by the particle monitor Mr. The monitor Mr then sends a detection signal to the MC 300. The MC 300 may thus know the number of particles passing through the roughing line L1 in real time.

The processing container C has a gate valve 498 on its side wall. With opening and closing the gate valve 498, the wafer W is transferred into the processing container C while maintaining the airtightness of the container C. According to this configuration, the PM operates as follows. The gas supply unit 445 supplies a process gas. The process gas is exited to generate a plasma by the high-frequency electric power from the high-frequency power supply 430. The plasma performs the etching process on the wafer W.

When the deposits on the interior wall of the processing container reach a predetermined thickness, the gas supply unit 445 supplies a cleaning gas into the container. The cleaning gas is then exited to generate a plasma by the high-frequency electric power from the high-frequency power supply 430. The plasma may clean the processing container interior. The container is cleaned periodically.

Also in this embodiment, after the processing container is cleaned, the NPPC is performed before and/or after a movable part disposed in the processing container is repeatedly moved. The interior of the processing container and the movable part may thus be effectively cleaned, as described below in more detail. Examples of the repeated motions of the movable parts include: opening and closing of the gate valve 498 to load/unload the wafer W; moving up and down of the stage bearing the wafer W; up-and-down motion of a lift pin 450a supporting the wafer W mounted on the stage; opening and closing of the valve element of the APC 490b; and opening and closing of the valves V1 and V2.

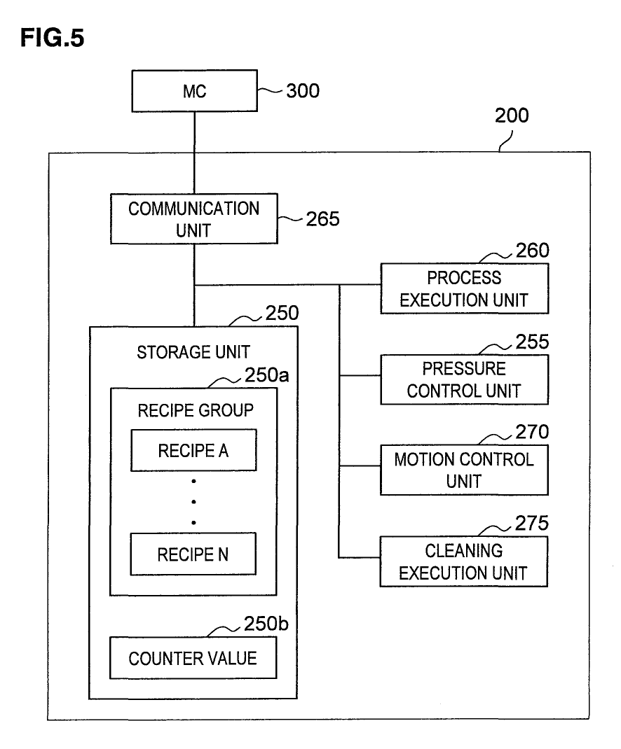

(Function Configuration of EC) FIG. 5 is a block diagram of functions of the EC200. With reference to FIG. 5, the function configuration of the EC is described. The EC 200 has functions shown by blocks of a storage unit 250, a pressure control unit 255, a process execution unit 260, a communication unit 265, a motion control unit 270, and a cleaning execution unit 275.

The storage unit 250 stores various recipes (recipe a to recipe n) as a recipe group 250a. The recipes show processing procedures to perform desired processes on the wafer W in each PM 400. The storage unit 250 also stores the number and driving time of repeated motions of each movable part counted during a previous cleaning of the PM 400 or LLM 500. The value is stored as a counter value 250b.

The pressure control unit 255 controls a flow rate of the purge gas supplied from the gas supply unit 445 into the processing container. The control portion 255 also controls a flow rate of the gas exhausted via the exhaust mechanism 490. These operations control the internal pressure of the processing container C. The process execution unit 260 selects a recipe specified by the operator from the storage unit 250. The execution unit 260 controls the etching process in the PM 400 according to a procedure indicated in the selected recipe. The etching process is performed on the wafer W transferred into the PM 400.

The communication unit 265 transmits and receives information mainly from the MC 300. The communication unit 265 delivers, for example, an instruction (control signal) of the etching process output from the process execution unit 260 to the MC 300. The MC 300 thus is instructed so as to perform a desired etching process in the PM 400. The motion control unit 270 controls the repeated motions of each movable part disposed in the PM 400 or LLM 500.

The cleaning execution unit 275 controls the purge-gas pressure to be equal to or more than a predetermined pressure before and/or during and/or after the repeated motions of each movable part. Alternatively, or additionally, the execution unit 275 allows the power supply to intermittently output energy before and/or after the repeated motions of each movable part.

In this way, the purge-gas pressure is controlled to be equal to or more than a predetermined pressure while the purge gas is flowed into and exhausted from the vacuum apparatus (such as the PM 400 or LLM 500), or the purge gas is flowed into and exhausted from the vacuum apparatus while the high-voltage power supply 485 is allowed to intermittently introduce the high voltage HV into the vacuum apparatus. These operations are referred to as the non plasma particle cleaning (NPPC), as described above. In this way, the repeated motions of each movable part or the NPPC performed before/after the repeated motions may positively peel the deposits, which cause the particles, from the PM 400 and LLM 500 and the movable parts disposed therein.

Note that the functions of the units in the EC 200 are actually provided as follows. A program (including a recipe) that describes the procedure in which the CPU 215 in FIG. 2 provides the functions is stored in storage media such as the ROM 205 and the RAM 210. The CPU 215 reads the program from the storage media. The CPU 215 then interprets the program and runs it to provide the functions. In this embodiment, for example, the functions of the pressure control unit 255, the process execution unit 260, the motion control unit 270, and the cleaning execution unit 275 are actually provided by the CPU 215 running the program that describes the procedure in which the CPU 215 provides these functions.

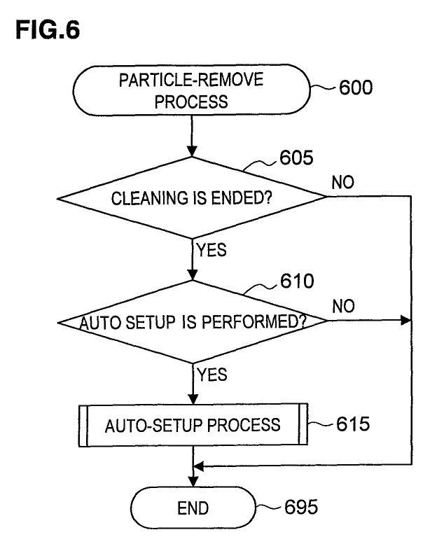

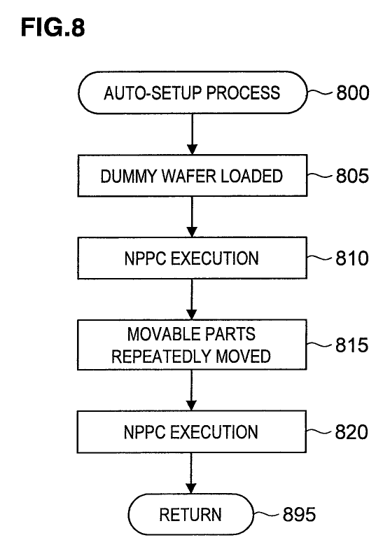

(Operation of EC) With reference mainly to the flowcharts shown in FIGS. 6 and 8, the cleaning process performed by the EC 200 will be described below. FIG. 6 shows a main routine showing the particle-remove process. FIG. 8 shows a sub routine showing the auto-setup process (including the cleaning process) called in the particle-remove process.

(Cleaning Process) The operator specifies the recipe and the lot number and turn “on” the lot start button. The relevant lot is then introduced into the process. The 25 wafers in the lot are sequentially transferred via the LLM 500 to the PM 400. The wafers are etched according to the specified recipe. The wafers are transferred back via the LLM 500 to be put back in the cassette. Repetition of such motions leads to the reaction products from the process gas deposited on the interior wall or the like in the PM 400 and LLM 500. Cleaning is thus necessary to remove the deposits from the interiors of the PM 400 and LLM 500. Cleaning gases are supplied into the interiors of the PM 400 and LLM 500. The gases are then exited to generate a plasma, by which the interiors are cleaned.

(Particle-Remove Process) After the cleaning, the particle-remove process starts at step 600 in FIG. 6. At step 605, the cleaning execution unit 275 determines whether the cleaning of the processing container is ended. If it is determined that the cleaning of the container is not ended, then control directly passes to step 695, where the particle-remove process is ended. If it is determined that the cleaning of the container is ended, then control passes to step 610. At this step, the cleaning execution unit 275 determines whether to perform the auto setup.

The auto setup is a process that automatically cleans the PM 400 according to an auto-setup recipe and automatically performs a setup such as an operation check of the PM 400. These processes may condition the interior of the PM 400.

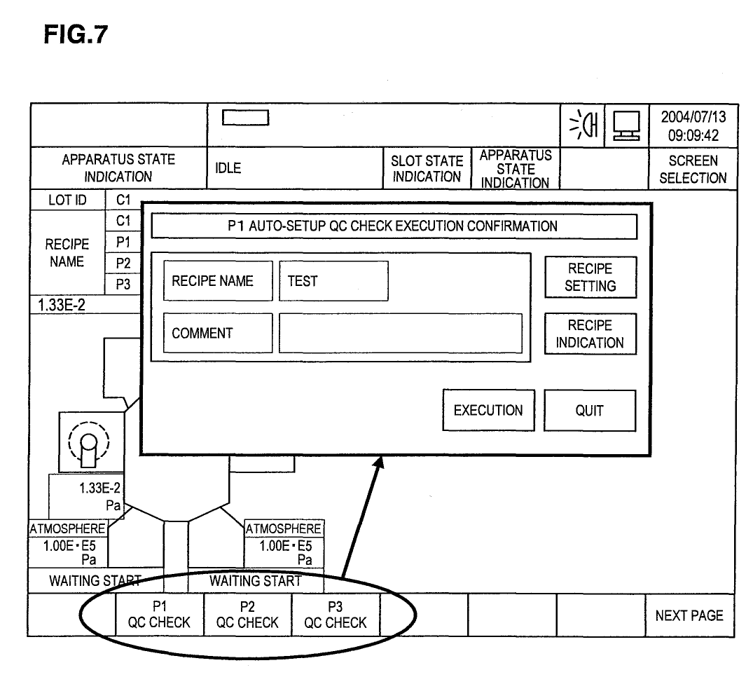

Whether to perform the auto setup is determined by the operator on the auto setup quality check (QC) execution confirmation screen in FIG. 7. Specifically, when the operator selects a QC check recipe and presses the “execute” key, the cleaning execution unit 275 determines that the auto setup is to be performed. Control then passes to step 615. At step 615, the cleaning execution unit 275 calls the auto-setup process shown in FIG. 8. After the auto-setup process is ended, the particle-remove process is ended at step 695. When the operator presses the “quit” key on the screen in FIG. 7, it is determined that the auto setup is not to be performed. Control then directly passes to step 695, where the particle-remove process is ended.

(Auto-Setup Process) The auto-setup process starts at step 800 in FIG. 8. The processes at step 805 to step 820 are then performed according to the auto-setup recipe. Specifically, at step 805, the cleaning execution unit 275 loads a dummy wafer (test wafer) into the PM 400. At step 810, the NPPC is performed.

Specifically, the NPPC includes the following operations. The pressure control unit 255 controls the purge-gas pressure to be twice or more the pressure of the processing container. The purge gas includes an inert gas such as N₂ gas. Alternatively, or additionally, the high-voltage power supply 485 is allowed to intermittently output the high voltage HV.

The pressure of the processing container is controlled within a range of 100 mTorr to 200 mTorr. The pressure control unit 255 may control the purge-gas pressure to approximately 3 atm. The purge gas then has a pressure four or more orders of magnitude higher than the pressure of the processing container. The high-pressure purge gas may be rapidly flowed into the processing container C, thereby peeling the deposits attached to the interior of the processing container and the movable parts. This is because the rapid purge gas causes shock waves in the processing container C, the waves causing physical oscillations that effectively peel the deposits.

Alternatively, or additionally, the high-voltage power supply 485 may output high voltages HV of approximately ±1 kV alternately. The dc voltages may be applied a few times instantaneously and alternately to the interior of the processing container C, thereby generating a direct current (DC) discharge. The discharge instantaneously forms a potential gradient at the wall surface of the processing container C and the stage of the lower electrode 450, the stage bearing the wafer W. The potential gradient may effectively generate an electromagnetic stress. The electromagnetic stress may effectively peel the deposits attached to the interior of the processing container and the movable parts disposed therein.

Control then passes to step 815, where the motion control unit 270 allows each movable part to move repeatedly. Specifically, the motion control unit 270 works as follows. The unit 270 allows the gate valve 498 for loading/unloading the wafer W to open and close repeatedly. The unit 270 also allows the stage of the lower electrode 450, the stage bearing the wafer W, to move up and down repeatedly. The unit 270 also allows the lift pin 450a supporting the wafer W mounted on the stage to move up and down repeatedly. The unit 270 also allows the valve element of the APC 490b to open and close repeatedly.

Control then passes to step 820, where the motions of each movable part are stopped and the NPPC is performed again. Specifically, the pressure control unit 255 controls the purge-gas pressure as described above. Additionally, the cleaning execution unit 275 allows the high-voltage power supply 485 to intermittently output the high voltage HV with the valve element of the APC 490b full open. Control then passes to step 895, where the auto-setup process is ended.

In this way, the purge gas is flowed and exhausted, each movable part is moved, and then the NPPC is performed. The deposits attached to those of the movable parts that are hard to clean when accommodated may thus be peeled off more effectively and be exhausted from the processing container.

Particularly, the NPPC may be performed as follows to peel off the deposits very effectively. When the processing container is at a low pressure (a high degree of vacuum), the purge-gas pressure is controlled to be twice or more the pressure of the processing container, and the high-voltage power supply 485 is allowed to intermittently output the high voltage HV with the valve element of the APC 490b full open. The processing container is then controlled to be at a high pressure (a low degree of vacuum) with the container roughed by the DP 490a, and the high-voltage power supply 485 is allowed to intermittently output the high voltage HV. The deposits may thus be peeled off very effectively. This is because the processing container has a higher resistance at a higher pressure than at a lower pressure, so when the high-voltage power supply 485 is allowed to intermittently output the high voltage HV, the deposits may be peeled off more easily.

Thus, the cleaning method according to this embodiment includes the following operations. The purge gas is introduced and exhausted while repeatedly moving those of the movable parts that are usually accommodated and hard to clean, and then the NPPC is performed. This may thus effectively remove the reaction products, which cause the particles, from the processing container C and the movable parts disposed therein using only the existing device (without using a new device). Higher cleanliness of the processing container may thus be provided, thereby minimizing the frequency of particles dropping on the wafer W, dramatically improving the product yield.

Note that the above discussion has focused on the cleaning of the PM 400, but the LLM 500 may also be cleaned in a similar way. Note, however, that the NPPC performed in the LLM 500 is as follows. The movable parts disposed in the LLM 500 (such as the transfer arm Arm in FIG. 3 and a not-shown exhaust mechanism) are repeatedly moved, and a purge gas whose pressure is controlled to be twice or more the internal pressure of the LLM 500 is introduced into the LLM 500 while the gas in the LLM 500 is exhausted via the exhaust mechanism.

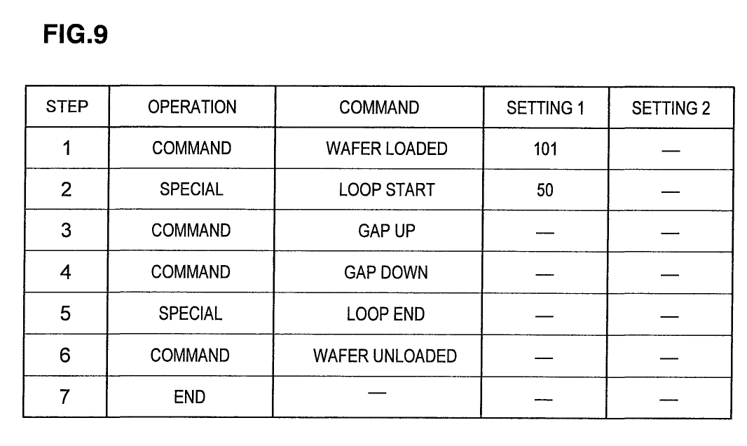

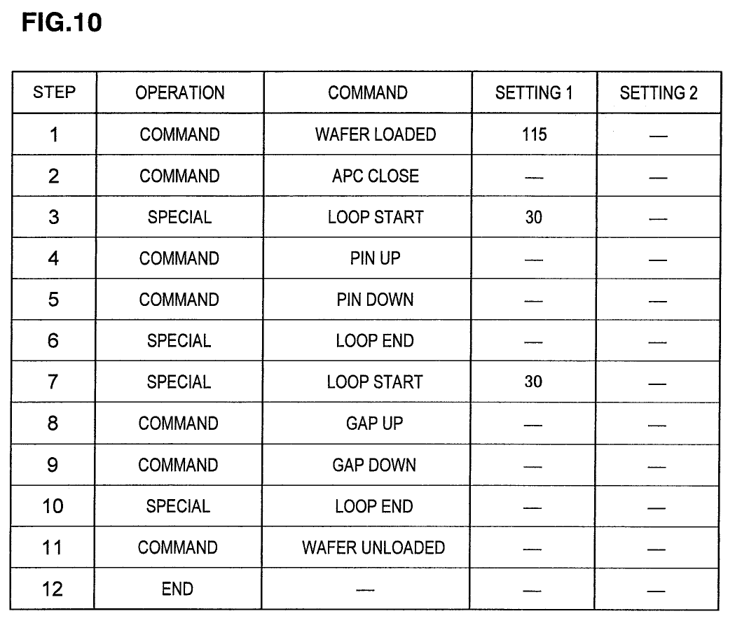

Preferably, the cleaning method according to this embodiment is performed after the PM 400 and LLM 500 are cleaned and when the auto setup is performed to condition their interiors. The auto-setup recipes in FIG. 9 and FIG. 10 thus describe the procedure of the method for cleaning the PM 400 and LLM 500. The method for cleaning the PM 400 or LLM 500 may thus be changed by only changing the auto-setup recipe. For example, the auto-setup recipe in FIG. 10 corresponds to the recipe in FIG. 9 plus steps 2 and 4 to 7 shown in FIG. 10. The repeated motions of the lift pin 450a may thus be added to the cleaning operations in this embodiment. The method for cleaning each container may thus be managed easily and accurately. Note, however, that the cleaning method according to this embodiment may be forcibly started when the operator operates the “NPPC” button.

In this embodiment, the NPPC is performed, then the movable parts are repeatedly moved, then the movable parts are stopped, and the NPPC is performed again, but it is not limited thereto. Alternatively, before and/or during and/or after the repeated motions of each movable part, the purge-gas pressure is controlled to be equal to or more than a predetermined pressure, or before and/or after the repeated motions of each movable part, the high-voltage power supply 485 is allowed to intermittently output energy.

Note, however, that when the high-voltage power supply 485 introduces energy into the processing container during the repeated motions of each movable part, each movable part may undergo a concentrated electrical field. The field may highly possibly cause an abnormal discharge. The high-voltage power supply 485 outputs energy, therefore, not during the repeated motions of each movable part but before and/or after the motions. The purge-gas pressure may be controlled to be equal to or more than a predetermined pressure before and/or during and/or after the repeated motions of each movable part.

### Second Embodiment

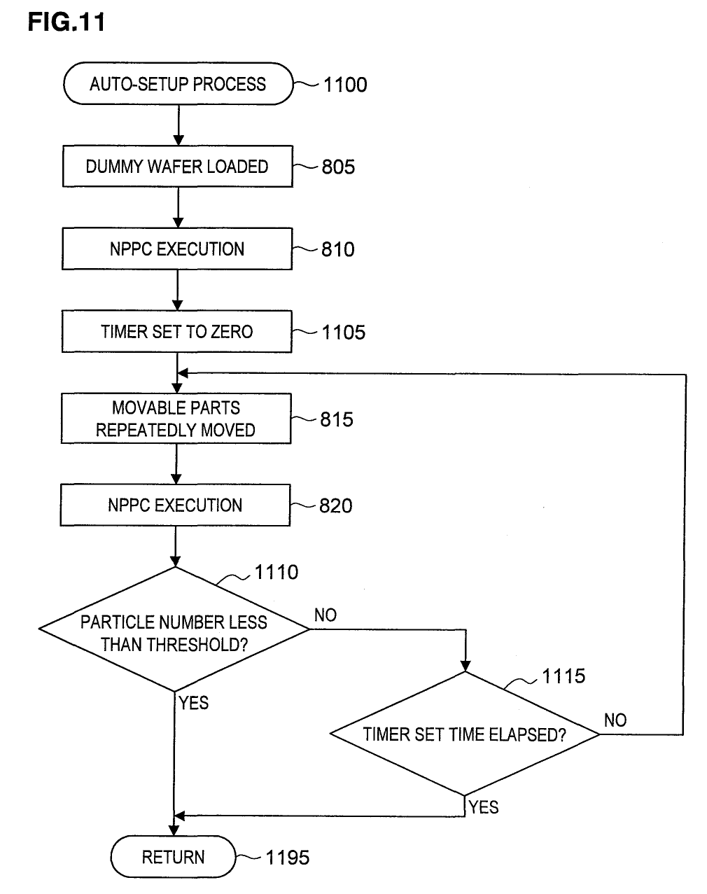

The cleaning method according to a second embodiment of the present invention will be described. The second embodiment differs from the first embodiment in that the particle monitor Mr is used to detect the number of particles, and when the detected number is less than a predetermined threshold, the cleaning is ended. In the first embodiment, the cleaning is ended according to the specification in the recipe. Focusing on the difference between the two embodiments, the cleaning method according to this embodiment will be described below with reference to FIG. 11.

In the second embodiment, step 615 in FIG. 6 calls the auto-setup process in FIG. 11. After step 1100, at steps 805 and 810, the cleaning execution unit 275 loads the dummy wafers and performs the NPPC as in the first embodiment. Control then passes to step 1105, where a not-shown timer is set to “0.” Then at step 815, the movable parts are repeatedly moved. Then at step 820, the NPPC is performed again.

Control then passes to step 1110, where the cleaning execution unit 275 compares, according to the number of particles detected by the particle monitor Mr, the number of particles passing through the roughing line L1 and a predetermined threshold. The execution unit 275 then determines whether the number of particles exhausted from the processing container is less than a predetermined threshold. If the number of particles is less than a threshold, then the cleaning execution unit 275 proceeds to step 1195, where the auto-setup process is ended. If the number of particles is equal to or more than a threshold, then the cleaning execution unit 275 proceeds to step 1115. At this step, it is determined whether a predetermined amount of time set by a timer has elapsed. If a predetermined amount of time has elapsed, then the cleaning execution unit 275 determines that the cleaning should be forcibly stopped even if the number of particles is equal to or more than a threshold. Control then passes to step 1195, where the auto-setup process is ended. If a predetermined amount of time has not elapsed yet, then the cleaning execution unit 275 determines that the cleaning should be continued because the number of particles is equal to or more than a threshold. Control then returns to step 815, and the processes at steps 815, 820, 1110, and 1115 are repeated. If the number of particles is less than a threshold or a predetermined amount of time has elapsed, then control passes to step 1195, where the auto-setup process is ended.

Thus, the cleaning method according to this embodiment includes the following operations. The movable parts of the PM 400 or LMM 500 are repeatedly moved, while the NPPC is performed and the number of particles from each movable part disposed in the PM 400 or LMM 500 is monitored by the particle monitor Mr. When the number of particles from each movable part is less than a predetermined threshold, the repeated motions of each movable part are ended.

The interior of the processing container may thus be cleaned to a degree that the number of particles from the movable parts is less than a predetermined value. This may thus sufficiently clean those of the movable parts that are accommodated. Those movable parts are hard to clean with the usual cleaning. Additionally, an amount of time after which the cleaning should be forcibly stopped may be set in advance and the cleaning may be stopped after the predetermined amount of time has elapsed.

The cleaning time may be determined as follows. During a previous auto-setup process, at step 1110, the time for the number of particles to be less than a predetermined threshold (i.e., the motion time between the start and stop of the repeated motions of the movable parts) is determined. The motion time is held in the storage unit 250 as the counter value 250b. The counter value 250b is then used to determine the cleaning time.

More specifically, at previous cleaning of the PM 400 or LLM 500, the motion time between the start and stop of the repeated motions of a plurality of the movable parts is counted. During the current cleaning of the PM 400 or LLM 500, when the number of repeated motions of the movable parts are equal to or more than a predetermined value corresponding to the counted motion time, the repeated motions of the movable parts may be stopped.

Alternatively, or additionally, the cleaning time may be determined as follows. During previous cleaning of the PM 400 or LLM 500, the number of motions between the start and stop of the repeated motions of each movable part is counted. During the current cleaning of the PM 400 or LLM 500, when the number of repeated motions of each movable part is equal to or more than a predetermined value corresponding to the number of motions counted for each movable part, the repeated motions of the movable parts may be stopped.

When, therefore, any of the movable parts has an abnormality that causes the number of particles from each movable part not to be equal to or less than a predetermined threshold, an empirical value corresponding to the number or motion time of motions of each movable part at previous cleaning may be used to limit the repeated motions of each movable part during the current cleaning, thereby forcibly stopping the cleaning process. When, therefore, for example, any of the movable parts has an abnormality in which the part generates particles due to mechanical wear or the like, it is possible to reduce particles generated by unnecessary motions of each movable part. Note that the number or time of repeated motions of each movable part during previous one time cleaning may be determined according to only the number or time of repeated motions during the preceding cleaning or according to an average of the number or time of repeated motions over a certain number of previous cleanings.

### Third Embodiment

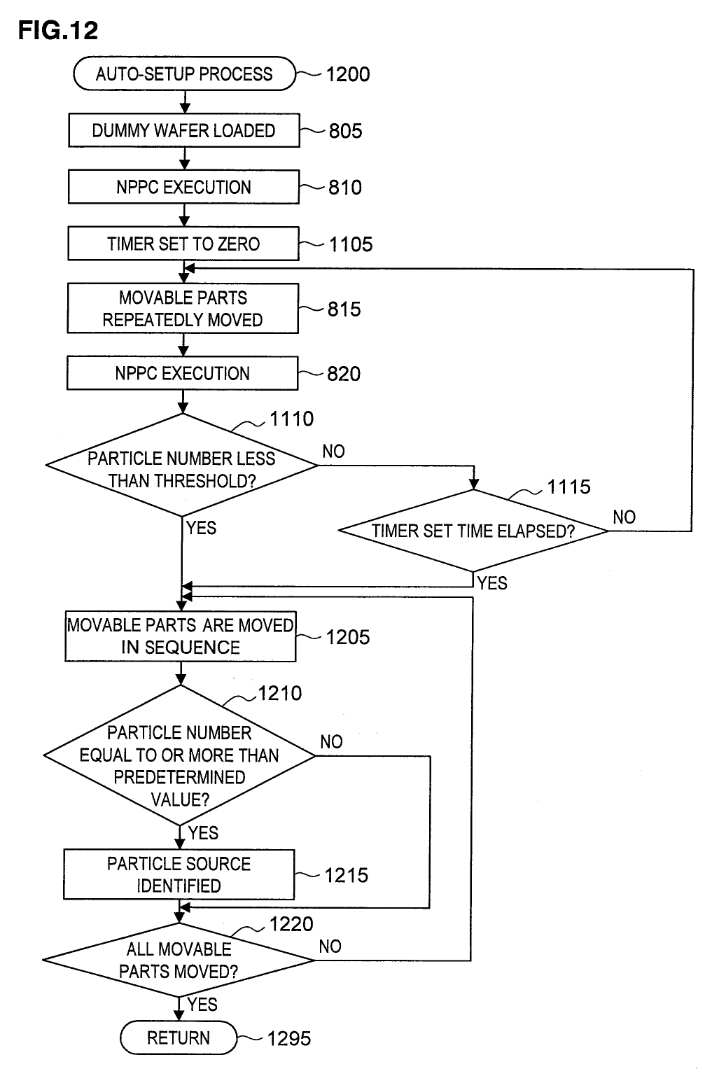

A cleaning method according to a third embodiment of the present invention will be described below. The third embodiment differs from the second embodiment in that the particle monitor Mr is used to detect the number of particles, and when the detected number is less than a predetermined threshold, the cleaning is ended, and then each movable part is moved separately, thereby identifying the particle source. In the second embodiment, the particle source is not identified. Focusing on the difference between the two embodiments, the cleaning method according to this embodiment will be described below with reference to FIG. 12.

In the third embodiment, step 615 in FIG. 6 calls the auto-setup process in FIG. 12. The cleaning execution unit 275 performs, as in the second embodiment, steps 1200, 805, 810, and 1105. The execution unit 275 then repeats steps 815, 820, 1110, and 1115, thereby continuing the cleaning process until the number of particles is less than a threshold or a predetermined amount of time has elapsed.

If the number of particles is less than a threshold at step 1110 or a predetermined amount of time has elapsed at step 1115, then control passes to step 1205. At this step, the motion control unit 270 allows each movable part to repeatedly move in sequence. Control then passes to step 1210, where the cleaning execution unit 275 determines whether each movable part generates particles equal to or more than a predetermined number for each movable part. The cleaning execution unit 275 determines whether or not the number of particles passing through the roughing line L1 detected by the particle monitor Mr is equal to or more than a predetermined value.

If the number of particles is equal to or more than a predetermined value, then control passes to step 1215. At this step, the cleaning execution unit 275 identifies the currently moving movable part as the particle source. Control then passes to step 1220, where the execution unit 275 determines whether all movable parts are moved. If the number of particles is less than a predetermined value, then the cleaning execution unit 275 does not identify the currently moving movable part as the particle source. Control then passes to step 1220, where the execution unit 275 determines whether all movable parts are moved.

Until the cleaning execution unit 275 determines, at step 1220, that all movable parts are moved, the execution unit 275 repeats the processes at steps 1205 to 1220. If the unit 275 determines, at step 1220, that all movable parts are moved, then control passes to step 1295, where the auto-setup process is ended.

Thus, the cleaning method according to this embodiment includes the following operations. The movable parts of the PM 400 or LMM 500 are repeatedly moved while the NPPC is performed to clean the PM 400 or LMM 500. Each movable part is then moved in sequence and the number of particles from each movable part is monitored by the particle monitor Mr. When the number of particles from a certain movable part is equal to or more than a predetermined value, that movable part is identified as the particle source. The operator may thus be prompted to exchange the identified movable part or further clean only that movable part.

The cleaning method according to this embodiment is also performed after the gas supply unit 445 supplies the cleaning gas to the processing container C to clean it. After the interior of the processing container C is cleaned, therefore, the number of particles from each movable part may be monitored by the particle monitor. The particle source may thus be identified more accurately.

The cleaning method according to this embodiment is also performed after the movable parts of the PM 400 or LMM 500 are repeatedly moved while the NPPC is performed to clean the PM 400 or LMM 500. The interior of the PM 400 or LMM 500 may thus be cleaned very well before the cleaning method according to this embodiment is performed. The particle source may thus be identified much more accurately.

Thus, according to each of the embodiments of the present invention, the deposits attached to the movable parts disposed in the vacuum apparatuses such as the PM 400 and LLM 500 may be effectively removed.

Note that the high-voltage power supply 485 may apply the dc voltage (HV) approximately one to ten times. Instead of the high-voltage power supply 485, the high-frequency power supply 430 may be used to apply an ac voltage (RF) intermittently and instantaneously.

The cleaning method disclosed in each of the embodiments may be applied to vacuum apparatuses other than the semiconductor processing unit such as the PM 400 and the transfer system such as the LLM 500. When the vacuum apparatus is the semiconductor processing unit, the processing container C contains various plasma processing systems including the etching system, the chemical vapor deposition (CVD) system, the ashing system, and the sputtering system to perform plasma processes on the target object such as the wafer. The vacuum apparatuses are not limited to the parallel-plate (capacitively-coupled) plasma processing system in FIG. 4. The vacuum apparatuses may also be the microwave plasma processing system and the inductively-coupled plasma processing system.

In the method for cleaning a vacuum apparatus, the cleaning execution unit 275 may perform the NPPC before and/or during and/or after the repeated motions of each movable part. When the unit 275 performs the NPPC before the repeated motions of each movable part, the interior of the processing container C may be cleaned well before the number of particles from each movable part is monitored by the particle monitor. The particle source may thus be identified more accurately. When the unit 275 performs the NPPC during and/or after the repeated motions of each movable part, the repeated motions of each movable part allow the deposits attached to the movable parts to be effectively peeled. The deposits attached to the interior wall of the vacuum apparatus and the movable parts disposed in the apparatus may thus be removed very effectively.

In the above embodiments, the operations of the units are related to each other. The operations may thus be replaced with a series of operations in consideration of the relations. Thus, a control device embodiment that controls a cleaning for vacuum apparatus can be led from the cleaning method embodiment for vacuum apparatus. The operations of the units may also be replaced with the processes by the units, thus a program embodiment that controls a cleaning for vacuum apparatus can be led from the cleaning method embodiment for vacuum apparatus. The program may be stored in a computer-readable storage medium, thus changing the program embodiment to a computer-readable storage medium embodiment recording the program.

The preferred embodiment of the present invention has been described with reference to the appended drawings, but it is clearly apparent that the present invention is not limited by this example. It should be understood by those skilled in the art that various modifications, combinations, sub-combinations and alterations may occur depending on design requirements and other factors insofar as they are within the scope of the appended claims or the equivalents thereof.

For example, the target object used in the present invention is not limited to the wafer (silicon wafer). The target object may also be, for example, the glass substrate used in displays such as the organic EL display, the plasma display, and the liquid crystal display (LCD).

What is claimed is:

1. A method for cleaning a vacuum apparatus, the vacuum apparatus including:
a chamber to process or transfer a target object;
a plurality of movable parts disposed in the chamber;
a power supply to introduce energy to the chamber;
a gas supply unit to supply a gas to the chamber; and
an exhaust mechanism to exhaust a gas in the chamber,
the method comprising:
supplying a purge gas from the gas supply unit and exhausting the purge gas in the chamber via the exhaust mechanism;
repeating a motion of each movable part; and
controlling the purge-gas pressure to be equal to or more than a predetermined pressure before and/or during and/or after the repeated motions of each movable part, and/or allowing the power supply to intermittently output energy before and/or after the repeated motions of each movable part in order to peel a deposit attached to the vacuum apparatus and each movable part.

2. The method for cleaning a vacuum apparatus according to claim 1, wherein
the purge-gas pressure is controlled to be twice or more the chamber pressure.

3. The method for cleaning a vacuum apparatus according to claim 1, wherein
the power supply outputs a positive voltage and a negative voltage alternately.

4. The method for cleaning a vacuum apparatus according to claim 1, wherein
the purge-gas pressure is controlled to be equal to or more than a predetermined pressure and/or the power supply is allowed to intermittently output energy with a valve element of a pressure controller full open, and then the power supply is allowed to intermittently output energy in order to peel a deposit attached to the vacuum apparatus and each movable part.

5. The method for cleaning a vacuum apparatus according to claim 1, wherein
while the method for cleaning a vacuum apparatus is performed, the number of particles in the chamber is monitored using a particle monitor, and
the repeated motions of the movable parts are stopped when the number of particles in the chamber is equal to or less than a predetermined threshold.

6. The method for cleaning a vacuum apparatus according to claim 5, wherein
when, in comparison with a motion time counted between the start and stop of the repeated motions of the movable parts during a previous cleaning of the vacuum apparatus, a time of the repeated motions of the movable parts during a current cleaning of the vacuum apparatus is equal to or more than a predetermined value corresponding to the counted motion time, the repeated motions of the movable parts are stopped regardless of the number of particles from the movable parts monitored by the particle monitor.

7. The method for cleaning a vacuum apparatus according to claim 5, wherein
when, in comparison with the number of motions counted between the start and stop of the repeated motions of each movable part during a previous cleaning of the vacuum apparatus, the number of repeated motions of the each movable part during a current cleaning of the vacuum apparatus is equal to or more than a predetermined value corresponding to the counted number of motions of the each movable part,
the repeated motions of the each movable part are stopped regardless of the number of particles from the movable parts monitored by the particle monitor.

8. The method for cleaning a vacuum apparatus according to claim 1, wherein
the method for cleaning a vacuum apparatus is performed before the repeated motions of each movable part, and then the gas supply unit supplies the purge gas and the exhaust mechanism exhausts the supplied purge gas, while each movable part is repeatedly moved in sequence and the number of particles from each movable part due to the repeated motions is monitored using a particle monitor.

9. The method for cleaning a vacuum apparatus according to claim 8, wherein
according to the number of particles from each movable part monitored by the particle monitor, a particle source is determined.

10. The method for cleaning a vacuum apparatus according to claim 9, wherein
the movable part determined as the particle source is informed to an operator.

11. The method for cleaning a vacuum apparatus according to claim 1, wherein
the motions of the movable parts comprise:
opening and closing of a gate valve to load/unload the target object;
moving up and down of a stage bearing the target object;
up-and-down motion of a lift pin supporting the target object mounted on the stage; and
opening and closing of a valve element of the pressure controller.

12. The method for cleaning a vacuum apparatus according to claim 1, wherein
the method for cleaning a vacuum apparatus is performed after the gas supply unit supplies a cleaning gas to the vacuum apparatus to clean it.

13. The method for cleaning a vacuum apparatus according to claim 12, wherein
the method for cleaning a vacuum apparatus is performed after the vacuum apparatus is cleaned using the cleaning gas and during auto setup for conditioning an interior of the chamber.

14. The method for cleaning a vacuum apparatus according to claim 1, wherein
the vacuum apparatus is a semiconductor processing unit.

15. A control device for controlling cleaning of a vacuum apparatus, the vacuum apparatus including:
a chamber to process or transfer a target object;
a plurality of movable parts disposed in the chamber;
a power supply to introduce energy to the chamber;
a gas supply unit to supply a gas to the chamber; and
an exhaust mechanism to exhaust a gas in the chamber,
the control device comprising:
a pressure control unit controlling the gas supply unit to supply a purge gas, the control unit also controlling the exhaust mechanism to exhaust the purge gas in the chamber;
a motion control unit controlling repeated motions of each movable part; and
a cleaning execution unit cleaning the vacuum apparatus by controlling the purge-gas pressure to be equal to or more than a predetermined pressure before and/or during and/or after the repeated motions of the each movable part, and/or allowing the power supply to intermittently output energy before and/or after the repeated motions of the each movable part in order to peel a deposit attached to the vacuum apparatus and the each movable part.

16. A computer-readable storage medium storing a control program that instructs a computer to clean a vacuum apparatus, the vacuum apparatus including:
a chamber to process or transfer a target object;
a plurality of movable parts disposed in the chamber;
a power supply to introduce energy to the chamber;
a gas supply unit to supply a gas to the chamber; and
an exhaust mechanism to exhaust a gas in the chamber,
the control program instructing the computer to execute modules comprising:
a module for controlling the gas supply unit to supply a purge gas and controlling the exhaust mechanism to exhaust the purge gas in the chamber;
a module for controlling repeated motions of each movable part; and
a module for cleaning the vacuum apparatus by controlling the purge-gas pressure to be equal to or more than a predetermined pressure before and/or during and/or after the repeated motions of the each movable part, and/or allowing the power supply to intermittently output energy before and/or after the repeated motions of the each movable part in order to peel a deposit attached to the vacuum apparatus and the each movable part.
